(19) United States
(12) Patent Application Publication
(10) Pub. No.: US 2016/0196576 A1
(43) Pub. Date: Jul. 7, 2016

(54) SYSTEMS, DEVICES, AND METHODS OF MEASURING AN ADVERTISING CAMPAIGN

(71) Applicant: Grok & Banter, Inc., New Orleans, LA (US)

(72) Inventors: Staacy Cannon, New Orleans, LA (US); Keegan Brown, New Orleans, LA (US); Chris Burrus, New Orleans, LA (US)

(73) Assignee: Grok & Banter, Inc., New Orleans, LA (US)

(21) Appl. No.: 14/979,928

(22) Filed: Dec. 28, 2015

Related U.S. Application Data
(60) Provisional application No. 62/099,629, filed on Jan. 5, 2015.

(51) Int. Cl. G06Q 30/02; G06K 9/78; G06K 9/00

(52) U.S. Cl. CPC G06Q 30/0246; G06K 9/00268; G06K 9/00255; G06K 9/00288; G06K 9/00604; G06K 9/78

(57) ABSTRACT

Advertising devices, systems, and methods of monitoring an effectiveness of an advertising campaign are disclosed. An advertising device includes one or more imaging devices, a processing device, and a storage medium. The storage medium includes programming instructions that, when executed, cause the processing device to receive image data from the one or more imaging devices. The image data includes information regarding one or more individuals located in a vicinity of an advertising channel. The storage medium further includes programming instructions that, when executed, cause the processing device to determine a total number of the individuals to generate reach data, determine a subset of the total number of individuals that corresponds to a number of engaged individuals that observe the advertising channel, determine a duration of engagement for each individual to generate engagement data, and transmit the reach data and the engagement data to a remote computing device.

### CROSS-REFERENCE TO RELATED APPLICATION

The present application claims priority to U.S. Provisional Patent Application Ser. No. 62/099,629, filed Jan. 5, 2015 and entitled “Systems and Methods for Determining Advertising Effectiveness,” which is incorporated by reference herein in its entirety.

### TECHNICAL FIELD

The present specification generally relates to systems, devices, and methods for monitoring and analyzing the effectiveness of advertising and, more specifically, to systems, devices, and methods that gather intelligence regarding individual users that view advertising.

### BACKGROUND

When companies undergo an advertising campaign, they may desire to determine the effectiveness of the campaign. That is, a company may desire to determine whether the advertising campaign is effective in obtaining the attention of one or more individuals, engaging the one or more individuals, convincing the one or more individuals to purchase a product or service that is being advertised, and/or the like. In addition, companies may desire real-time monitoring so that adjustments to advertising funding can be made on the fly. As such, an industry surrounding advertising intelligence has sprung up to service this need.

Current advertising campaign effectiveness solutions include systems that incorporate an imaging device at the location of the advertisement in an attempt to capture user activity in front of the advertisement. However, such systems transmit image data to a remote computing device for analysis and processing, which results in privacy concerns surrounding the security of the transmissions and the potential for a breach. In addition, such systems may be a target for litigation because such systems obtain personal data for individuals without their permission.

Accordingly, a need exists for systems and methods that do not transmit image data to reduce the chances of a breach and to protect the privacy of the individuals observing an advertisement.

### SUMMARY

In one embodiment, an advertising device includes one or more imaging devices, a processing device, and a non-transitory, processor-readable storage medium. The non-transitory, processor-readable storage medium includes one or more programming instructions that, when executed, cause the processing device to receive image data from the one or more imaging devices. The image data includes information regarding one or more individuals located in a vicinity of an advertising channel. The non-transitory, processor-readable storage medium further includes one or more programming instructions that, when executed, cause the processing device to determine a total number of the individuals to generate reach data, determine a subset of the total number of individuals that corresponds to a number of engaged individuals that observe the advertising channel, determine a duration of engagement for each individual in the subset to generate engagement data, and transmit the reach data and the engagement data to a remote computing device.

In another embodiment, a method of monitoring an effectiveness of an advertising campaign includes receiving, by a processing device, image data from the one or more imaging devices, wherein the image data comprises information regarding one or more individuals located in a vicinity of an advertising channel, determining, by the processing device, a total number of the individuals to generate reach data, determining, by the processing device, a subset of the total number of individuals that corresponds to a number of engaged individuals that observe the advertising channel, determining, by the processing device, a duration of engagement for each individual in the subset to generate engagement data, and transmitting, by the processing device, the reach data and the engagement data to a remote computing device.

In yet another embodiment, an advertising system includes an advertising channel, one or more imaging devices, a local computing device communicatively coupled to the one or more imaging devices, and a remote computing device communicatively coupled to the local computing device. The local computing device includes a first processor and a first non-transitory, processor-readable storage medium having a first one or more programming instructions that, when executed, cause the first processor to receive image data from the one or more imaging devices, determine a total number of individuals present in the image data to generate reach data, determine a subset of the total number of individuals that corresponds to a number of engaged individuals that observe the advertising channel, determine a duration of engagement for each individual in the subset to generate engagement data, and transmit the reach data and the engagement data to the remote computing device. The remote computing device includes a second processor and a second non-transitory, processor-readable storage medium having a second one or more programming instructions that, when executed, cause the second processor to receive the reach data and the engagement data and calculate a reaction rate from the reach data and the engagement data.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a block diagram of the various components of an illustrative advertising system according to one or more embodiments shown and described herein;

FIG. 2 schematically depicts a block diagram of illustrative computer processing hardware components according to one or more embodiments shown and described herein;

FIG. 3 schematically depicts a viewing area of an illustrative imaging device according to one or more embodiments shown and described herein;

FIGS. 4A-4C depict illustrative faces recognized by one or more components of the advertising system of FIG. 1 according to one or more embodiments shown and described herein;

FIG. 5 schematically depicts a flow diagram of an illustrative method of generating engagement data from image data according to one or more embodiments shown and described herein;

FIG. 6 schematically depicts a flow diagram of an illustrative method of determining a subset of engaged users according to one or more embodiments shown and described herein;

FIG. 7 schematically depicts a flow diagram of an illustrative method of receiving data and determining a reaction rate according to one or more embodiments shown and described herein; and

FIG. 8 schematically depicts a flow diagram of an illustrative method of extracting data from unique user information according to one or more embodiments shown and described herein.

### DETAILED DESCRIPTION

The embodiments described herein are generally directed to systems and methods of capturing image data at or near an advertisement, generating data from the image data such as a total number of individuals (reach data), a number of engaged individuals, and a duration of engagement for each individual (engagement data), transmitting the data to an external computer, and purging the image data to protect the privacy of people captured in the image data. The systems and methods described herein may also extract and transmit additional information from the image data, such as, for example, unique identifier data that corresponds to a unique individual, but does not contain any identifying information that would violate a person's privacy. Thus, the systems and methods disclosed herein may qualify a consumer and quantify the number of opportunities the consumer has to see an advertisement, as well as a number of times the consumer engages with the advertisement.

The systems and methods described herein provide an advantage over other systems and/or methods because they do not transmit any personally identifying data, particularly image data, to a remote computing device, therefore avoiding privacy issues due to intercepted transmissions, data breaches, and/or the like. In addition, the systems and methods described herein automatically purge image data as soon as it is received and processed such that no or relatively little image data is stored on the local device located at the advertising channel. Thus, in the event of a local security breach, little or no personal data would be compromised.

The systems and methods described herein may provide marketers and advertisers with an efficient means of split testing campaigns (i.e., testing a plurality of advertising campaigns at the same time) and/or split testing channels (i.e., testing a plurality of advertising channels at the same time) to determine the most effective means of providing an advertisement to consumers and potential consumers. The systems and methods described herein may further allow an advertising agency and/or a client of the advertising agency to quickly and easily shift budgets and channels based on the determination.

As used herein, an “advertising channel” generally refers to any system or device that provides an advertisement, particularly an advertisement that is situated such that a plurality of individuals have an opportunity to view the advertisement. The advertising channel may refer to a single advertising location or a plurality of locations (e.g., the same type of advertisement provided at a plurality of different advertising locations).

In some embodiments, the advertising channel may be an out-of-home advertising channel. That is, the advertisement is at a location that is not within a private location, such as, for example, a person's home, private offices, and/or the like. In addition, the advertisement may not be located on an individual or entity's private electronic device, such as, for example, a television, a computer, a portable electronic device, and/or the like. An illustrative out-of-home advertising channel may include, but is not limited to, a poster, a billboard, and a wall scape. For example, the poster may be a wall poster for advertising a product such as a movie or the like, a poster located on or in public transit vehicles, a poster located at a bus stop, and/or the like. In another example, the billboard may be a highway sign, a large sign in a highly trafficked area, and/or the like. In yet another example, a wall scape may be a billboard or similar advertisement that is presented on the side of a building, particularly a building in a landmark location in a city. Out-of-home advertising channels may provide still images, video images, interactive displays, or a combination thereof. Other out-of-home advertising channels not specifically described herein should be understood as being included within the scope of the present disclosure.

In some embodiments, the advertising channel may be an in-home advertising channel. That is, the advertisement may be provided to an individual or entity's private device and/or provided in a private location such as a person's home, private offices, and/or the like. In such embodiments, the advertising channel may use a private device to obtain image data and process the image data before transmitting to a remote computing device, as described in greater detail herein. In-home advertising channels may provide still images, video images, or a combination thereof. It should be understood that other in-home advertising channels not specifically described herein are included within the scope of the present disclosure.

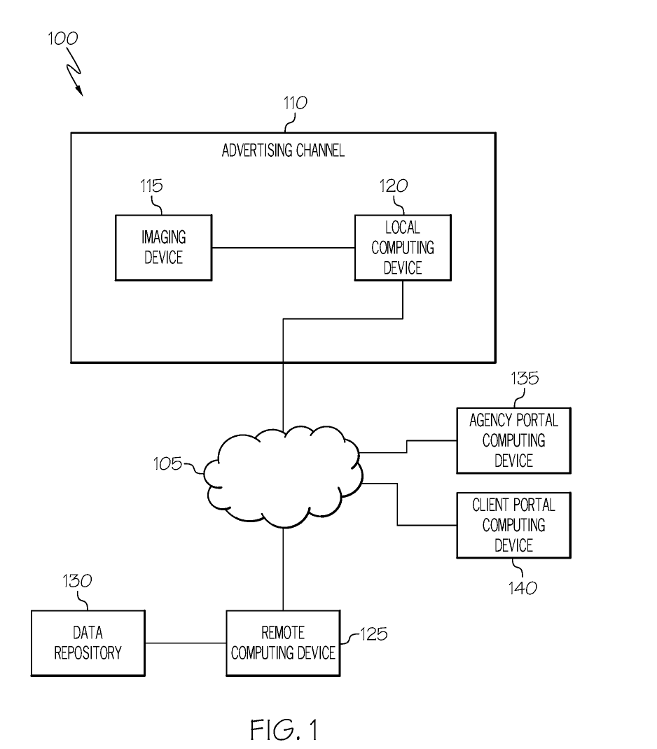

Referring now to the figures, FIG. 1 depicts a block diagram of the various components of an advertising system 100. The advertising system 100 may generally include a computer network 105. As illustrated in FIG. 1, the computer network 105 may include a wide area network (WAN), such as the Internet, a local area network (LAN), a mobile communications network, a public service telephone network (PSTN), a personal area network (PAN), a metropolitan area network (MAN), a virtual private network (VPN), and/or another network. The computer network 105 may be configured to electronically connect one or more computing devices and/or components thereof. Illustrative computing devices may include, but are not limited to, a local computing device 120, a remote computing device 125, an agency portal computing device 135, and a client portal computing device 140.

The local computing device 120 refers generally to a computing device that is positioned at or near an advertising channel 110. The local computing device 120 is local in the sense that it is local to the advertising channel 110. That is, the local computing device 120 is within a vicinity of the advertising channel 110. For example, in some embodiments, the local computing device 120 may be embedded in the advertising channel 110. In other embodiments, the local computing device 120 may be physically attached to the advertising channel 110, such as, for example, an existing advertising channel 110 that has been retrofitted with the local computing device 120. In other embodiments, the local computing device 120 may be positioned at a distance from the advertising channel 110 such that its field of view captures the advertising channel 110 and any individuals observing the advertising channel 110.

In various embodiments, the local computing device 120 may be coupled to an imaging device 115. The local computing device 120 may be coupled via any wired or wireless means now known or later developed. Thus, the local computing device 120 may be coupled to the imaging device 115 via one or more wires, cables, and/or the like, or may be coupled via a secure wireless connection using one or more wireless radios, such as, for example, Bluetooth, a 802.11 standard, near field communication (NFC), and/or the like. In some embodiments, the local computing device 120 may be coupled to the imaging device 115 via a wired means to avoid interception of signals and/or data transmitted between the imaging device 115 and the local computing device 120. In some embodiments, the imaging device 115 may be integrated with the local computing device 120 (e.g., a component of the local computing device 120). In other embodiments, the imaging device 115 may be a standalone device that is separate from the local computing device 120. In some embodiments, the imaging device 115 and the local computing device 120 may be combined into a single unit that is integrated with the advertising channel 110.

The imaging device 115 is not limited by this disclosure, and may generally be any device that captures images. In some embodiments, the imaging device 115 may be a camera, camcorder, or the like, and may incorporate one or more image sensors, one or more image processors, one or more optical elements, and/or the like. The imaging device 115 may be capable of zooming in and out and may further be capable of moving, such as, for example, panning, tilting, and/or the like. In some embodiments, the imaging device 115 may be capable of tracking a moving object, such as an individual moving at or near advertising channel 110. In some embodiments, movement of the imaging device 115 may be remotely controlled by a user. In some embodiments, the imaging device 115 may incorporate one or more other imaging-related features such as, for example, one or more motion sensors. For example, the imaging device 115 may generally be in an inactive state (not recording activity), and activate when one or more motion sensors incorporated therewith detect movement.

While FIG. 1 depicts a single imaging device 115, it should be understood that any number of imaging devices may be used without departing from the scope of the present disclosure. For example, the imaging device 115 may be a plurality of imaging devices arranged to capture an image in tandem, such as, for example, to capture a larger field of view than what would be possible with a single imaging device 115 or to capture a plurality of different angles of the same field of view. In another example, a plurality of imaging devices 115 may be used to capture various angles of a particular area at or near the advertising channel 110.

In some embodiments, the imaging device 115 may capture high dynamic range (HDR) images. In some embodiments, the imaging device 115 may capture images successively (e.g., “burst mode” capture), may capture single images at particular intervals, and/or may capture motion images (e.g., video capture). In embodiments where images are captured at particular intervals, illustrative intervals may include, but are not limited to, every second, every 2 seconds, every 3 seconds, every 4 seconds, or the like. In addition to capturing images, the imaging device 115 may record information regarding the image capture, such as, for example, a time stamp of when the image was captured, a frame rate, a field of view, and/or the like. Each captured image and the recorded information may be transmitted as image data to the local computing device 120.

The local computing device 120 may be configured to receive the image data from the imaging device 115, process the image data to obtain generated data, and transmit the generated data to the remote computing device 125, as described in greater detail herein.

As the local computing device 120 and the imaging device 115 are located at or near the advertising channel 110, it should be understood that, in some embodiments, the advertising channel 110 may be a single unit that incorporates an advertising display, the local computing device 120, and the imaging device 115. In some embodiments, the advertising channel 110 may be particularly designed and configured for providing an advertisement. For example, the advertising channel 110 may be a billboard that incorporates the local computing device 120 and the imaging device 115. In other embodiments, the advertising channel 110 may be a device that can be used for other purposes. For example, the advertising channel 110 may be a portable electronic device such as a smartphone, a tablet, or a phablet that incorporates, among other components, a display, the imaging device 115 and the local computing device 120.

While a single advertising channel 110 is depicted in FIG. 1, it should be understood that a plurality of advertising channels 110 (each containing an imaging device 115 and a local computing device 120 associated therewith) may be connected to the computer network 105 without departing from the scope of the present disclosure. For example, as described in greater detail herein, the remote computing device 125 may interface with a plurality of advertising channels 110 to obtain information regarding whether each advertising channel 110 is successful or unsuccessful so that advertising funding can be adjusted towards successful advertising channels 110.

The remote computing device 125 may generally be a computing device that is positioned at a location that is remote to the local computing device 120 and the advertising channel 110. The remote computing device 125 may interface with the local computing device 120 over the computer network 105 via any wired or wireless connection now known or later developed. In addition to receiving data from the local computing device 120, the remote computing device 125 may transmit data to the local computing device 120 and may further interface with any one of a data repository 130 coupled thereto, the agency portal computing device 135, and/or the client portal computing device 140. In some embodiments, the remote computing device 125 may analyze the data received from the local computing device 120 to determine real-time metrics, as described in greater detail herein.

The data repository 130 may generally be a data storage device, such as a data server, a cloud-based sever, a physical storage device, a removable media storage device, or the like. The data repository 130 may be integrated with the remote computing device 125 (e.g., a component of the remote computing device 125) or may be a standalone unit. In addition, while FIG. 1 depicts a single data repository 130, it should be understood that a plurality of data repositories may be used without departing from the scope of the present disclosure. The data repository 130 may generally receive data from one or more sources such as the remote computing device 125 and store the data. In addition, the data repository 130 may selectively provide access to the data and/or transmit the data.

The agency portal computing device 135 may generally be a computing device that is connected to at one or more of the computing devices described herein, either via a direct connection or via the computer network 105, to send and/or receive data. In some embodiments, the agency portal computing device 135 may be operated and/or controlled by an advertising agency or the like for the purposes of distributing information to and/or from one or more advertising agency clients. Thus, in some embodiments, the agency portal computing device 135 may be located at an advertising agency. In some embodiments, the agency portal computing device 135 may provide a user with an interface to measure and analyze an advertising campaign in real time based on the information received from the remote computing device 125. For example, the agency portal computing device 135 may provide one or more software as a service (SaaS) web applications for interfacing with one or more users.

The client portal computing device 140 may generally be a computing device that is connected to one or more of the other computing devices described herein (such as, for example, the remote computing device 125 and the agency portal computing device 135), either via a direct connection or via the computer network 105, to send and/or receive data. In some embodiments, the client portal computing device 140 may be operated and/or controlled by any individual and/or entity that is a client of the advertising agency. In some embodiments, the client portal computing device 140 may transmit and/or receive data to or from the remote computing device 125 and/or the agency portal computing device 135. In some embodiments, the client portal computing device 140 may provide a user with an interface to measure and analyze an advertising campaign in real time based on the information received from the remote computing device 125 and/or the agency portal computing device 135. For example, the agency portal computing device 135 may provide one or more software as a service (SaaS) web applications that allow one or more users to connect to the agency portal computing device 135 via the client portal computing device 140. In some embodiments, the client portal computing device 140 may allow clients of the advertising agency to access advertising effectiveness data, which may optionally be based on data received from the remote computing device 125 and/or the agency portal computing device 135. The client portal computing device 140 may also provide a user interface that includes campaign budget integration tools that allow the advertising agency to shift funding between various advertising channels (e.g., decrease funding for a failing channel and increase funding for a successful channel) in real time. In some embodiments, the client portal computing device may provide one or more application programming interfaces (APIs) that allow existing media company web applications to integrate with the user interface provided on the client portal computing device 140.

While FIG. 1 depicts a single local computing device 120, a single remote computing device 125, a single agency portal computing device 135, and a single client portal computing device 140, it should be understood that each computing device may embody a plurality of computing devices without departing from the scope of the present disclosure. For example, the remote computing device 125 may receive data from a plurality of local computing devices 120, such as a computing device located at each of a plurality of advertising channels 110. In another example, the remote computing device 125 may interface with a plurality of different agency portal computing devices 135.

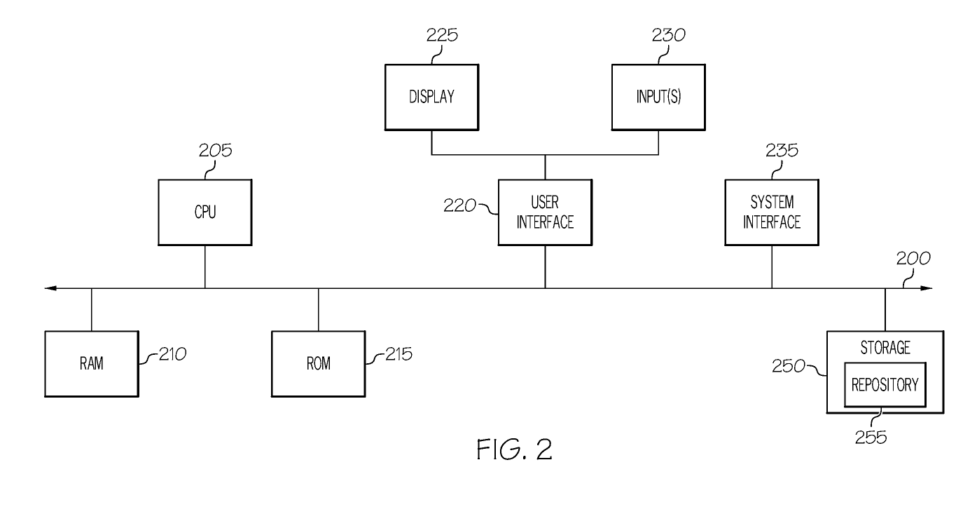

Any of the computing devices shown in FIG. 1 may include one or more hardware components thereof. For example, the local computing device 120 may contain one or more hardware components that allow the local computing device 120 to obtain image data, generate data from the image data, and transmit the generated data to the remote computing device 125. In another example, the remote computing device 125 may contain one or more hardware components that allow the remote computing device 125 to receive data from the local computing device 120, process the data, and direct the data repository 130 to store the data. Illustrative hardware components of the local computing device 120, the remote computing device 125, the agency portal computing device 135, and/or the client portal computing device 140 are depicted in FIG. 2. A bus 200 may interconnect the various components. A processing device, such as a computer processing unit (CPU) 205, may be the central processing unit of the computing device, performing calculations and logic operations required to execute a program. The CPU 205, alone or in conjunction with one or more of the other elements disclosed in FIG. 2, is an illustrative processing device, computing device, processor, or combination thereof, as such terms are used within this disclosure. Memory, such as read only memory (ROM) 215 and random access memory (RAM) 210, may constitute illustrative memory devices (i.e., non-transitory processor-readable storage media). Such memory 210, 215 may include one or more programming instructions thereon that, when executed by the CPU 205, cause the CPU 205 to complete various processes, such as the processes described herein. Optionally, the program instructions may be stored on a tangible computer-readable medium such as a compact disc, a digital disk, flash memory, a memory card, a USB drive, an optical disc storage medium, such as a Blu-ray™ disc, and/or other non-transitory processor-readable storage media.

A storage device 250, which may generally be a storage medium that is separate from the RAM 210 and the ROM 215, may contain a repository 255 for storing the various data described herein. For example, the repository 255 may be the data repository 130 that is integrated with the remote computing device 125 (FIG. 1), as described herein. The storage device 250 may be any physical storage medium, including, but not limited to, a hard disk drive (HDD), memory, removable storage, and/or the like. While the storage device 250 is depicted as a local device, it should be understood that the storage device 250 may be a remote storage device, such as, for example, a server computing device, cloud based storage, and/or the like.

An optional user interface 220 may permit information from the bus 200 to be displayed on a display 225 portion of the computing device in audio, visual, graphic, or alphanumeric format. Moreover, the user interface 220 may also include one or more inputs 230 that allow for transmission to and receipt of data from input devices such as a keyboard, a mouse, a joystick, a touch screen, a remote control, a pointing device, a video input device, an audio input device, a haptic feedback device, and/or the like. Such a user interface 220 may be used, for example, to allow a user to interact with one of the computing devices depicted in FIG. 1 or any component thereof. For example, a user may interact with the agency portal computing device 135 and/or the client portal computing device 140 to obtain information from the data that has been processed by the remote computing device 125 (FIG. 1).

A system interface 235 may generally provide the computing device with an ability to interface with one or more external components, such as, for example, any of the other computing devices, the imaging device 115 (FIG. 1) (if the computing device is the local computing device 120), and/or the data repository 130 (if the computing device is the remote computing device 125). Communication with external components may occur using various communication ports (not shown). An illustrative communication port may be attached to a communications network, such as the Internet, an intranet, a local network, a direct connection, and/or the like.

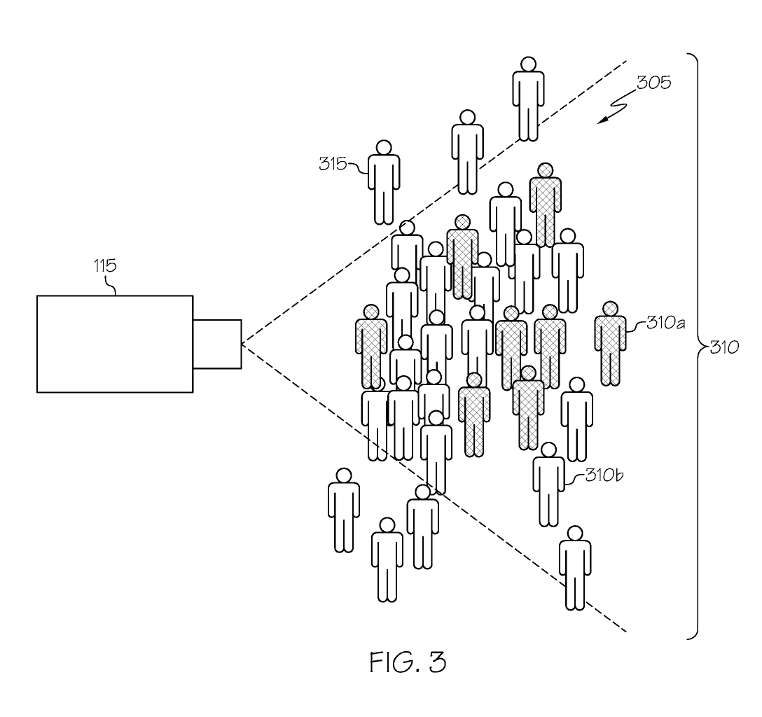

Referring to FIG. 3, a field of view 305 of the imaging device 115 is depicted. The field of view 305 may generally be a maximum angular viewing range for the imaging device 115. That is, the field of view 305 refers to what the imaging device 115 “sees” when it is obtaining image data. Thus, as shown in FIG. 3, the field of view 305 is bounded by the dashed lines; objects located between the dashed lines are within the field of view 305, whereas objects located outside the area bounded by the dashed lines are not within the field of view 305. The field of view 305 may generally be shaped and sized based on various components contained within the imaging device 115. For example, the field of view 305 may be dependent on the size of one or more image sensor portions of the imaging device 115, a range of focal lengths of one or more lenses coupled to the imaging device 115, and/or the like. The shape and size of the field of view 305 is not limited by this disclosure, and may generally be any shapes and/or sizes now known or later developed. In some embodiments, the field of view 305 may be a fixed field of view where the imaging device 115 captures images from a fixed area. In some embodiments, the field of view 305 may be a moving field of view, where movement of the imaging device 115 allows it to capture images from a plurality of different areas. In some embodiments, the field of view 305 may be a panoramic or 360° field view, where the imaging device 115 contains one or more components that allow it to rotate or otherwise capture a full panoramic or 360° image. In some embodiments, the field of view 305 may be the result of a plurality of imaging devices 115 capturing an image in tandem. In such embodiments, the field of view 305 may be stitched together from the respective individual fields of view of each of the plurality of imaging devices 115.

In various embodiments, one or more present individuals 310 may be located within the field of view 305 of the imaging device 115 and one or more non-present individuals 315 may be located outside the field of view. The one or more non-present individuals 315 may generally be disqualified for the purposes of generating and processing the data as described herein, as they are not imaged by the imaging device 115. Each of the one or more present individuals 310 within the field of view 305 may be an engaged individual 310a or an unengaged individual 310b. An engaged individual 310a may generally be a present individual 310 that is determined to be observing the advertising channel 110 (FIG. 1), as described in greater detail herein. In contrast, an unengaged individual 310b may generally be a present individual 310 that is determined to be not observing the advertising channel 110 (FIG. 1).

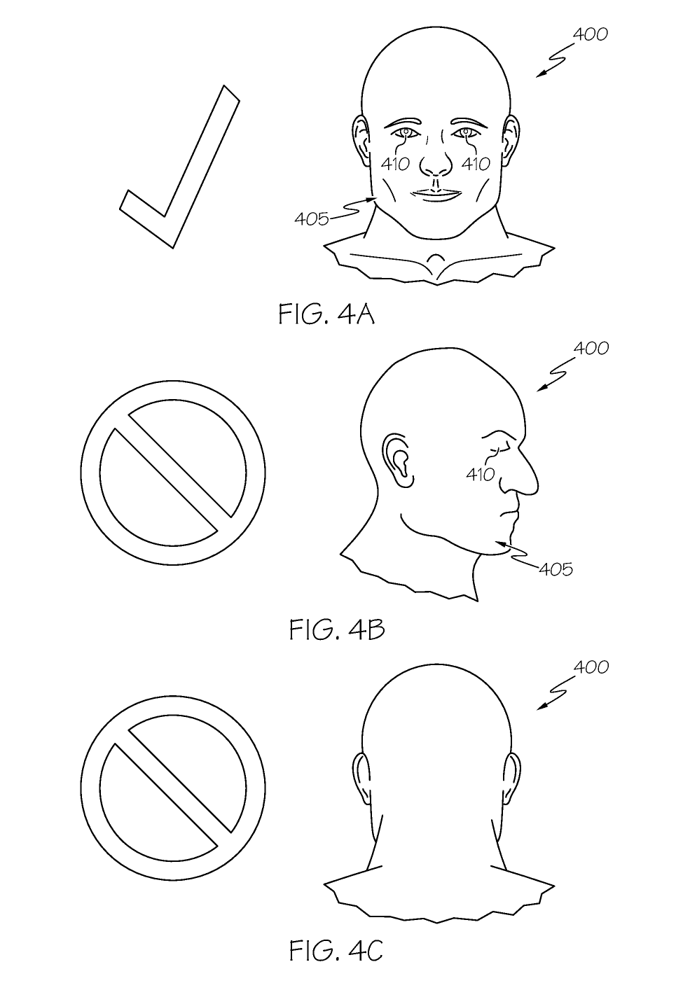

Referring also to FIGS. 4A-4C, an imaging device 115 that is incorporated within an advertising channel 110 (FIG. 1) may capture images of individuals in various states of engagement based on whether they are facing the imaging device 115 and the advertising channel 110 (FIG. 1). As shown in FIG. 4A, an individual 400 may be determined to be an engaged individual 310a if the image captured by the imaging device 115 depicts a face 405 having two eyes 410 facing the imaging device 115. However, as shown in FIG. 4B, if the individual 400 is only partially facing the imaging device 115 such that the captured image only shows a face 405 having a single eye 410 facing the imaging device 115, the individual 400 may be qualified as unengaged individual 310b. Similarly, as shown in FIG. 4C, if the individual 400 is completely facing away from the imaging device 115 such that no face or eyes are captured, the individual 400 may be qualified as an unengaged individual 310b. It should be understood that the examples provided with respect to FIGS. 4A-4C are merely illustrative, and that an individual 400 may be qualified as an engaged individual 310a or an unengaged individual 310b using other determinations without departing from the scope of the present disclosure. For example, an individual 400 may be qualified as an engaged individual 310a if the imaging device 115 is positioned away from the advertising channel 110 (FIG. 1) such that the imaging device 115 captures at least a portion of the advertising channel 110 in the field of view 305 and the individual 400 is determined to be looking at the advertising channel 110, but not facing the imaging device 115. In another example, an individual 400 may be determined to be an engaged individual 310a or an unengaged individual 310b based on certain other facial and/or other body features, such as expression, gaze, and/or the like.

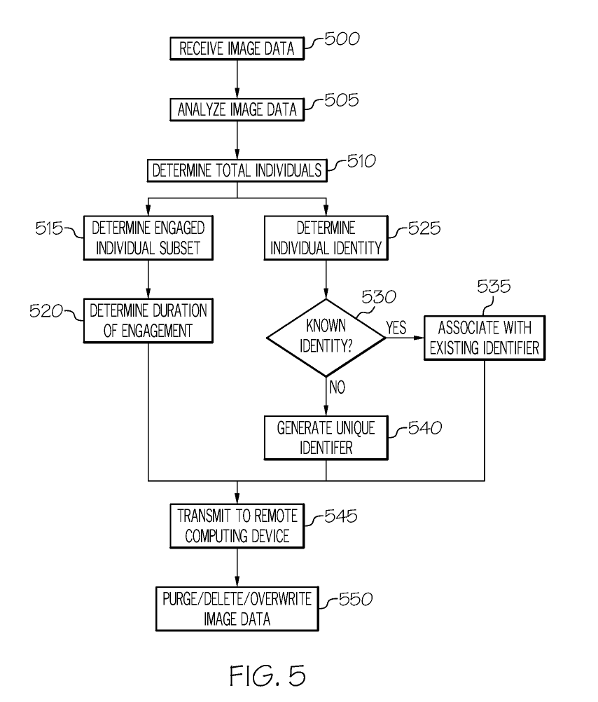

Referring again to FIG. 1, determining an engagement of a user may be completed by the local computing device 120 that is coupled to the imaging device 115 such that image data captured by the imaging device 115 is never transmitted to the remote computing device 125, thereby mitigating or reducing the possibility of violating an individual's privacy. Violating an individual's privacy is mitigated or reduced because no personally identifying information is transferred over the computer network 105. Rather, only data that has been generated by the local computing device 120 is transferred over the computer network 105. Moreover, the generated data cannot be traced back to the image data collected by the imaging device 115 because the image data is purged shortly after it is received by the local computing device 120 (such as by overwriting or deleting the data). Referring also to FIG. 5, the local computing device 120 may complete one or more steps in determining engagement and generating engagement data therefrom.

In step 500, the local computing device 120 may receive image data. The image data may generally be received from the one or more imaging devices 115 coupled to the local computing device 120. As previously described herein, the image data may contain information regarding one or more images captured by the one or more imaging devices 115. For example, the image data may contain one or more images of a field of view of each imaging device 115 at particular time intervals. In another example, the image data may contain a plurality of images in the form of a video clip captured by each imaging device 115. In some embodiments, the image data may contain information regarding one or more individuals that are at or near the advertising channel 110. Particularly, the information may include information relating to an orientation of various portions of each individual's body. In addition, the information may include information regarding to certain features of each individual. Thus, in step 505, the local computing device 120 may analyze the image data to obtain the information contained therein and generate data therefrom, as described in greater detail herein. In some embodiments, the local computing device 120 may analyze video at a particular frame rate, in particular intervals, at particular time stamps, or the like. In a nonlimiting example, the local computing device 120 may analyze video at 20 frames per second in 3 second intervals and time stamps 1 and 60 (or the third second of the last frame).

In step 510, the local computing device 120 may determine a total number of individuals present in the image data. Such a determination may include counting the number of individuals present in each image, which should generally correspond to the number of individuals present at or near the advertising channel 110. Determining the total number of individuals may include discerning between humans and other objects, such as, for example, inanimate objects present within the image data, animals, and/or the like. Discerning between humans and other objects may include determining whether certain features generally associated with humans are present, such as, for example, a head, a torso, one or more limbs, and/or the like. It should be generally recognized that other means of discerning between humans and other objects are included without departing from the scope of the present disclosure. In addition, discerning between humans and other objects may include recognizing that a subject is a live human and not a photograph, a painting, and/or the like. In some embodiments, the local computing device 120 may use any commercially available profile recognition software to discern between humans and other objects.

Certain additional information may be obtained in addition to the determination of the total number of individuals, including, but not limited to, whether each individual is a unique individual (i.e., whether the individual passes through the field of view of the imaging device 115 one time, is pacing back and forth in and out of the field of view, and/or the like), a time stamp for when each individual is captured, including when the individual is first captured and when the individual is last captured, a location of the individual (such as a general geographic location, a specific geographic location, a location relative to the advertising channel 110, a location relative to other individuals, and/or the like), data regarding the imaging device 115, such as positioning of the imaging device 115, location of the imaging device 115, photo capturing mode, frame rate, and/or the like, information typically contained within RAW data associated with the image data, and/or the like. The total number of individuals and the information associated therewith may be categorized as reach data. The reach data may be used to determine a reaction rate, as described in greater detail herein.

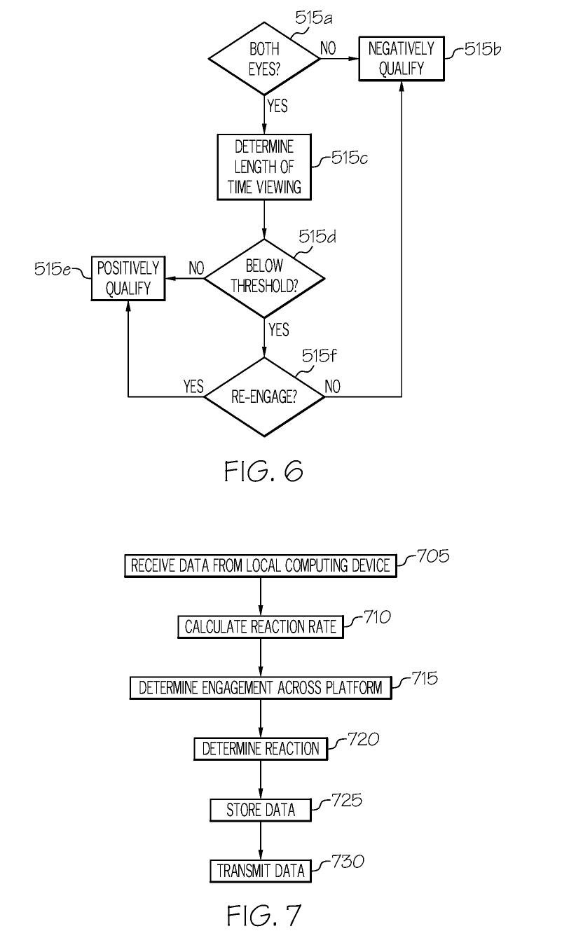

In step 515, the local computing device 120 may determine an engaged individuals subset. The engaged individuals subset may be a number of individuals that are engaged with the advertising channel 110. That is, the engaged individuals subset may be a subset of the total number of individuals that were determined in step 510. Determining the engaged individuals subset may include analyzing the image data to determine an orientation of each individual's head, an individual's gaze, an individual's expression, an individual's body movement, and/or the like. For example, as shown in FIG. 6, the local computing device 120 may determine whether both of the individual's eyes are visible in the image data in step 515a. Presence of both of the eyes may be indicative that the individual is facing the imaging device 115, and thus the advertising channel 110. In contrast, presence of neither eye or only one eye may be indicative that the individual is not facing the imaging device 115, and thus not facing the advertising channel 110. If both of the individual's eyes are not visible, the local computing device 120 may negatively qualify the individual in step 515b and not place the individual in the engaged individuals subset.

If both of the individuals eyes are visible, the local computing device 120 may determine the length of time the individual is facing the imaging device 115 (and is assumed to be viewing the advertising channel 110) in step 515c. In some embodiments, an individual may be negatively qualified and not placed in the engaged individuals subset if the duration of engagement is less than a threshold time. Thus, as shown in step 515d, the local computing device 120 may determine whether the length of time is below the threshold. The threshold time is not limited by this disclosure, and may generally include any time. In some embodiments, the threshold time may be about 1 second. In some embodiments, the threshold time may be set by an administrator and based on preferences of the administrator.

If the length of time is greater than the threshold, the individual may be positively qualified in step 515e and placed into the engaged individuals subset. If the length of time is less than the threshold, the local computing device 120 may determine whether the individual becomes reengaged in step 515f. An individual may become reengaged if he or she views the advertising channel 110 again within a certain time period. For example, if the individual becomes distracted and momentarily glances away from the advertising channel 110, but then returns to viewing the advertising channel 110 within a certain time period, the individual may be determined to be reengaged. The time period is not limited by this disclosure, and may be any time. For example, in some embodiments, the time period may be about 30 seconds to about 10 minutes, including about 30 seconds, about 1 minute, about 2 minutes, about 3 minutes, about 4 minutes, about 5 minutes, about 6 minutes, about 7 minutes, about 8 minutes, about 9 minutes, about 10 minutes, or any value or range between any two of these values (including endpoints). In some embodiments, the time period may be set by an administrator and based on preferences of the administrator.

If the individual becomes reengaged within the time period, the individual may be positively qualified in step 515e and added to the subset of engaged individuals. If the individual does not become reengaged within the time period, the individual may be negatively qualified in step 515b and not included within the subset of engaged individuals.

Referring again to FIGS. 1 and 5, in some embodiments, the local computing device 120 may also determine whether each individual is engaged by analyzing the image data to discern particular facial features for each individual, certain body features, and/or the like. Particular facial and/or body features that are indicative of whether a user is engaged should generally be recognized.

In some embodiments, in addition to determining which individuals are engaged, the local computing device 120 may also determine additional information, including, but not limited to, whether each engaged individual is a unique individual (i.e., whether the engaged individual passes through the field of view of the imaging device 115 one time, is pacing back and forth in and out of the field of view, and/or the like), information regarding whether the engaged individual becomes disengaged and/or reengaged, a time stamp for when each engaged individual is captured, including when the engaged individual is first captured in an engaged state and when the engaged individual is last captured in an engaged state, a location of the engaged individual (such as a general geographic location, a specific geographic location, a location relative to the advertising channel 110, a location relative to other engaged and/or unengaged individuals, and/or the like), data regarding the imaging device 115, such as positioning of the imaging device 115, location of the imaging device 115, photo capturing mode, frame rate, and/or the like, information typically contained within RAW data associated with the image data, and/or the like.

In step 520, the local computing device 120 may determine a duration of engagement for each engaged individual in the engaged individuals subset. Determining the duration of engagement may include, for example, determining a first specific time at which the individual becomes engaged with the advertising channel 110, determining a second specific time at which the individual becomes disengaged with the advertising channel 110, and calculating the amount of time that has elapsed between the first specific time and the second specific time. The duration of engagement for each of the individuals in the engaged users subset may generally be referred to herein as engagement data. The engagement data may later be used in determining a reaction rate of the individual, as described in greater detail herein.

In some embodiments, an individual may be engaged with the advertising channel 110, become briefly disengaged, and then reengage with the advertising channel 110. For example, an individual may observe the advertising channel 110 and become distracted, causing the individual to look away. However, the individual may again observe the advertising channel 110 once the distraction has passed. In such embodiments, the system may determine the duration of engagement based on the total time in which the user is engaged, the longest engagement period between disengagement period(s), or a first or last engagement period. In some embodiments, the various engagement periods may be grouped together and classified as a single engagement by that individual. In other embodiments, the various engagement periods may be separated and classified as separate engagements by the individual.

In some embodiments, the local computing device 120 may determine an identity of each individual in step 525. Determining the identity may include extracting certain facial characteristics, body features, movement, gait, and/or the like that distinguish between individuals such that the local computing device 120 is able to determine whether each individual in the image data is a newly recognized individual or an individual who has previously been recognized. Determining the identity of each individual does not include determining an individual's name, personal information, and/or the like. Rather, the identity is merely used as a reference by the local computing device 120 to determine whether the same individual has observed the advertising channel 110 in the past. In a nonlimiting example, the identity of the individual may be based on a combination of certain facial or body characteristics that can only be attributed to a particular individual. In some embodiments, the local computing device 120 may use any commercially available profile and/or facial recognition software to determine the identity of each individual. Certain profile and/or facial recognition software programs that are suitable for such a determination should generally be understood.

In step 530, the local computing device 120 may determine whether the identity of the user is known. Such a determination may include searching a database of unique identifiers to determine whether the features of the individual match the features of a previously identified individual. If the individual is known, any new information obtained regarding the individual is associated with the existing identifier in step 535. If the individual is not known, a new unique identifier is associated with the individual in step 540. The unique identifier may generally include information that allows only the local computing device 120 to determine whether the individual has previously viewed the advertising channel 110 in the past, as well as certain characteristics of the individual that will allow the local computing device 120 to identify the individual in the future. In a nonlimiting example, in some embodiments, the unique identifier may be a alphanumerical code or the like that is associated with an entry in a database. In another nonlimiting example, the unique identifier may include a first initial of basic demographics. The first initial of basic demographics may include information relating to particular features of an individual (or a combination of features) that uniquely identify the user with respect to other users, but could not otherwise be used to determine the identity of the user. In yet another nonlimiting example, the unique identifier may include a time stamp, which may generally reflect the time at which the individual was identified and/or observed at or near the advertising channel 110. The unique identifier, once transmitted away from the local computing device 120 (such as to the remote computing device 125) can no longer be used to identify the user. Rather, the remote computing device 125 can merely recognize the number of unique individuals, the number of times each individual has observed the advertising channel 110, and engagement information regarding each individual. As such, privacy data regarding the identity of each individual is protected such that each individual's privacy cannot be compromised in the event of a breach, interception of data transmissions, and/or the like.

In some embodiments, steps 515 and 520 may be completed at generally the same time as steps 525-540. That is, the local computing device 120 can determine the engaged individual subset and the duration of engagement at substantially the same time that it determines the identity of each individual. In other embodiments, steps 515-540 may be completed in succession. In some embodiments, steps 525-540 may be omitted to further protect the privacy of the individuals captured by the imaging device 115.

In step 545, the local computing device 120 may transmit the data generated in steps 510-540 to the remote computing device 125. The generated data may be transmitted over the computer network 105, as described in greater detail herein. In some embodiments, data may be transmitted in one or more packets. For example, a first packet may include activation status of the advertising channel 110, the imaging device 115 and/or the local computing device 120, an internet protocol (IP) address, and/or other device identifying information. A second packet may include the data generated in steps 515-520, and a third packet may include an algorithmic representation of the information that was obtained in steps 525-540, including demographic information, location information, and physical characteristics of each individual. It should be understood that such division of the data in to packets is merely illustrative, and that greater or fewer packets of data may be transmitted in step 454 without departing from the scope of the present disclosure.

In some embodiments, the imaging device 115 may continuously collect image data and transmit the image data to the local computing device 120 for processing. Because of this, the computing device may purge the previously obtained and processed image data in step 550 to make room for the new image data. Purging the image data may include deleting the image data, overwriting the image data, and/or the like. As such, once the image data is processed according to steps 510-540, it is purged so that it can no longer be accessed, thereby ensuring the privacy of the individuals captured in the image data is not compromised.

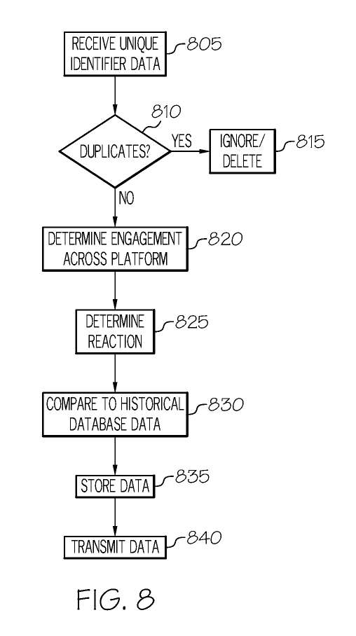

Referring to FIGS. 1 and 7, the remote computing device 125 may receive and further process the data generated by the local computing device 120. In step 705, the remote computing device 125 may receive the data from the local computing device 120. The data may generally be received via the computer network 105, as described in greater detail herein.

In step 710, the remote computing device 125 may calculate a reaction rate from the generated data for each of the engaged individuals. The reaction rate may refer to the number of times an individual engages with the advertising channel 110 out of the total opportunities available to the individual to engage with the advertising channel 110. In some embodiments, the reaction rate Rxn may be calculated according to Equation 1:

$$Rxn = \frac{E}{R} \qquad ( 1 )$$

where E is the engagement data, and R is the reach data. Thus, the reaction rate is the amount of time an individual is engaged with the advertising channel 110, divided by the total number of times that person was quantified by the reach data (i.e., total number of times the individual was observed within the field of view of the imaging device 115 but not engaged with the advertising channel 110).

In embodiments where the remote computing device 125 receives data from a plurality of different local computing devices 120, each located at a different advertising channel 110, the remote computing device 125 may determine engagement across a whole platform in step 715. That is, the remote computing device 125 may compare various reaction rates for individuals observing each of the advertising channels 110 to determine a total reaction in step 720 and also to compare reaction rates between each of the advertising channels 110, where the advertising channels 110 display the same or similar advertisements. The comparison may be used, for example, to determine an effectiveness of a particular advertising channel 110, which may be used by one or more agencies or clients in determining whether to continue an advertising campaign at a particular advertising channel 110, increase advertising at a particular advertising channel 110, decrease advertising at a particular advertising channel 110, and/or the like. In some embodiments, such a comparison may be used to determine a funnel depth of a particular advertising campaign or of a particular advertising channel 110. The funnel depth may generally refer to a number of advertisements that must be displayed to a particular individual before the individual engages with the advertising channel 110.

The comparison of engagement across all of the advertising channels 110 may be stored as data in step 725. In addition, the reaction rate data for each of the individuals may also be stored as data in step 725. The data may be stored, for example, in the data repository 130.

In step 730, the remote computing device 125 may transmit data to one or more devices. In some embodiments, the remote computing device 125 may transmit data to the agency portal computing device 135. In some embodiments, the remote computing device 125 may transmit data to the client portal computing device 140. The data may generally be transmitted via the computer network 105, as described in greater detail herein.

Transmitting the data to the agency portal computing device 135 and/or the client portal computing device 140 may allow users of such computing devices to analyze the data and make determinations regarding the effectiveness of a particular advertising campaign, the effectiveness of a particular advertising channel 110, and/or the like. From those determinations, a user of the agency portal computing device 135 and/or the client portal computing device 140 may adjust advertising spending to particular campaigns and/or channels. In some embodiments, a user interface that allows for such adjustments may be provided by any one of the computing devices described herein, such as, for example, the agency portal computing device 135, the client portal computing device 140, and the remote computing device 125.

Referring to FIGS. 1 and 8, the remote computing device 125 may complete additional processes with respect to the unique identifier data generated by the local computing device 120. In step 805, the remote computing device 125 may receive the unique identifier data from the local computing device 120. The data may generally be received via the computer network 105, as described in greater detail herein.

In some embodiments, the unique identifier data may contain duplicate information, which is only recognizable by the remote computing device 125 because the identifier is identical to an already-stored identifier in the data repository 130. In such embodiments, the remote computing device 125 may determine in step 810 that duplicates exist and ignore or delete the duplicates in step 815.

In embodiments where the remote computing device 125 receives data from a plurality of different local computing devices 120, each located at a different advertising channel 110, the remote computing device 125 may determine unique identifiers across a whole platform in step 820. That is, the remote computing device 125 may compare unique identifiers for individuals observing each of the advertising channels 110 to determine a total reaction in step 825 and also to compare unique identifiers between each of the advertising channels 110. The comparison may be used, for example, to determine an effectiveness of a particular advertising channel 110, which may be used by one or more agencies or clients in determining whether to continue an advertising campaign at a particular advertising channel 110, increase advertising at a particular advertising channel 110, decrease advertising at a particular advertising channel 110, and/or the like. For example, certain advertising channels 110 may receive more unique individuals than other advertising channels 110.

In some embodiments, the remote computing device 125 may compare the unique identifier data to historical database data in step 830. The comparison may be used to determine, for example, the effectiveness of an advertising campaign over time.

The comparison of unique identifiers across all of the advertising channels 110 may be stored as data in step 835. The data may be stored, for example, in the data repository 130.

In step 840, the remote computing device 125 may transmit data to one or more devices. In some embodiments, the remote computing device 125 may transmit data to the agency portal computing device 135. In some embodiments, the remote computing device 125 may transmit data to the client portal computing device 140. The data may generally be transmitted via the computer network 105, as described in greater detail herein.

Transmitting the data to the agency portal computing device 135 and/or the client portal computing device 140 may allow users of such computing devices to analyze the data and make determinations regarding the effectiveness of a particular advertising campaign, the effectiveness of a particular advertising channel 110, and/or the like. From those determinations, a user of the agency portal computing device 135 and/or the client portal computing device 140 may adjust advertising spending to particular campaigns and/or channels. In some embodiments, a user interface that allows for such adjustments may be provided by any one of the computing devices described herein, such as, for example, the agency portal computing device 135, the client portal computing device 140, and the remote computing device 125.

Accordingly, the devices and methods described herein generate information from image data locally at an advertising channel, and send the generated information to a remote computing device that is remote from the advertising channel for processing. Subsequently, the image data is purged. Such a generation of data at a computing device that is local to the advertising channel reduces or mitigates the potential for a violation of an individual's privacy because the private data (an individuals' face or other identifying characteristics) is only contained within the image data, which is not stored in long term storage and is never transmitted away from the advertising channel.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An advertising device comprising:
one or more imaging devices;
a processing device; and
a non-transitory, processor-readable storage medium, wherein the non-transitory, processor-readable storage medium comprises one or more programming instructions that, when executed, cause the processing device to:
receive image data from the one or more imaging devices, wherein the image data comprises information regarding one or more individuals located in a vicinity of an advertising channel,
determine a total number of the individuals to generate reach data,
determine a subset of the total number of individuals that corresponds to a number of engaged individuals that observe the advertising channel,
determine a duration of engagement for each individual in the subset to generate engagement data, and
transmit the reach data and the engagement data to a remote computing device.

2. The advertising device of claim 1, wherein the non-transitory, processor-readable storage medium further comprises one or more programming instructions that, when executed, cause the processor to:
determine an identity for each of the total number of individuals,
generate unique identifier data for each identity, and
transmit the unique identifier data to the remote computing device.

3. The advertising device of claim 2, wherein the unique identifier comprises at least one of a numerical code, a first initial of basic demographics, a unique code, and a time stamp.

4. The advertising device of claim 1, wherein the non-transitory, processor-readable storage medium further comprises one or more programming instructions that, when executed, cause the processor to purge the image data.

5. The advertising device of claim 1, wherein the one or more programming instructions that, when executed, cause the processing device to determine a subset of the total number of individuals further cause the processing device to, for each individual located in the vicinity of the advertising channel:
determine an amount of time in which the individual is facing the advertising channel;
if the individual is facing the advertising channel for a period of time that is less than a threshold amount, negatively qualify the individual; and
if the individual is facing the advertising channel for a period of time that is greater than or equal to the threshold amount, positively qualify the observer and place the observer in the subset.

6. The advertising device of claim 5, wherein the threshold is one second.

7. The advertising device of claim 1, wherein the one or more programming instructions that, when executed, cause the processing device to receive image data from the one or more data capturing devices further comprises causing the processing device to continuously receive image data from the one or more data capturing devices.

8. The advertising device of claim 1, wherein the advertising channel is arranged at or near the one or more imaging devices.

9. A method of monitoring an effectiveness of an advertising campaign, the method comprising:
receiving, by a processing device, image data from the one or more imaging devices, wherein the image data comprises information regarding one or more individuals located in a vicinity of an advertising channel,
determining, by the processing device, a total number of the individuals to generate reach data,
determining, by the processing device, a subset of the total number of individuals that corresponds to a number of engaged individuals that observe the advertising channel,
determining, by the processing device, a duration of engagement for each individual in the subset to generate engagement data, and
transmitting, by the processing device, the reach data and the engagement data to a remote computing device.

10. The method of claim 9, further comprising:
determining, by the processing device, an identity for each of the total number of individuals,
generating, by the processing device, unique identifier data for each identity, and
transmitting, by the processing device, the unique identifier data to the remote computing device.

11. The method of claim 9, further comprising:
purging, by the processing device, the image data.

12. An advertising system comprising:
an advertising channel;
one or more imaging devices;
a local computing device communicatively coupled to the one or more imaging devices; and
a remote computing device communicatively coupled to the local computing device,
wherein the local computing device comprises a first processor and a first non-transitory, processor-readable storage medium comprising a first one or more programming instructions that, when executed, cause the first processor to:
receive image data from the one or more imaging devices,
determine a total number of individuals present in the image data to generate reach data,
determine a subset of the total number of individuals that corresponds to a number of engaged individuals that observe the advertising channel,
determine a duration of engagement for each individual in the subset to generate engagement data, and
transmit the reach data and the engagement data to the remote computing device, and
wherein the remote computing device comprises a second processor and a second non-transitory, processor-readable storage medium comprising a second one or more programming instructions that, when executed, cause the second processor to:
receive the reach data and the engagement data, and
calculate a reaction rate from the reach data and the engagement data.

13. The advertising system of claim 12, wherein the first non-transitory, processor-readable storage medium further comprises one or more programming instructions that, when executed, cause the first processor to:
determine an identity for each of the total number of individuals present in the image data,
generate unique identifier data for each identity, and
transmit the unique identifier data to the remote computing device.

14. The advertising system of claim 12, wherein the first non-transitory, processor-readable storage medium further comprises one or more programming instructions that, when executed, cause the first processor to purge the image data.

15. The advertising system of claim 12, wherein the second one or more programming instructions that, when executed, cause the second processor to calculate the reaction rate comprises dividing the engagement data by the reach data to determine the reaction rate.

16. The advertising system of claim 12, wherein the second non-transitory, processor-readable storage medium further comprises one or more programming instructions that, when executed, cause the second processor to transmit the reach data, the engagement data, and the reaction rate to at least one of an agency portal and a client portal.

17. The advertising system of claim 12, wherein the second non-transitory, processor-readable storage medium further comprises one or more programming instructions that, when executed, cause the second processor to determine an engagement across a campaign platform from the engagement data.

18. The advertising system of claim 12, further comprising a data repository, wherein the data repository stores the unique identifier, the reach data, the engagement data, and the reaction rate.

19. The advertising system of claim 12, wherein the advertising channel comprises at least one of a poster, a billboard, and a wall scape.

20. The advertising system of claim 12, wherein the one or more imaging devices comprise one or more motion sensors.
